(19) United States
(12) Patent Application Publication
(10) Pub. No.: US 2023/0372778 A1
(43) Pub. Date: Nov. 23, 2023

(54) METHOD AND SYSTEM FOR PROVIDING IMMERSIVE AND INTERACTIVE FITNESS EXPERIENCE TO A USER

(71) Applicant: RAJIV TREHAN, BANGKOK (TH)

(72) Inventor: RAJIV TREHAN, BANGKOK (TH)

(21) Appl. No.: 18/198,317

(22) Filed: May 17, 2023

Related U.S. Application Data
(60) Provisional application No. 63/342,640, filed on May 17, 2022.

(51) Int. Cl. A63B 24/00; G06V 10/70; G06T 15/20; G06V 20/20; G06V 40/20

(52) U.S. Cl. CPC A63B 24/0075; G06V 10/70; G06T 15/205; G06V 20/20; G06V 40/23; A63B 24/0006; A63B 24/0062; A63B 2071/0638

(57) ABSTRACT

The invention relates to method and system for providing an immersive and interactive fitness experience to a user is disclosed. The method includes identifying a pose and a movement corresponding to the user performing one or more activities in a real-world environment; generating, in a metaverse or a virtual environment, an avatar corresponding to the user of the real-world environment based on the pose and the movement identified; rendering the pose and the movement identified in the avatar using an Extended Reality (XR) technique; monitoring a pattern of the one or more activities being performed by the user in the real-word environment and the corresponding avatar in the metaverse or the virtual environment using an Artificial Intelligence (AI) model; and dynamically providing a feedback to at least one of the user and the avatar based on the monitoring.

### TECHNICAL FIELD

Generally, the invention relates to metaverse technology. More specifically, the invention relates to providing an immersive and interactive fitness experience to a user.

### BACKGROUND

The word “metaverse” refers to a completely immersive 3-dimensional (3D) virtual universe that incorporates a virtual environment in which human users are represented by avatars. More particularly, the metaverse may be a 3D online space where users, avatars, and Artificial Intelligence (AI) may co-exist and interact. Any of the users may engage with other user in the 3D online space through their avatars or software agents, both socially and commercially. Within the metaverse, the users may engage with each other, form groups, and perform a variety of activities such as exercises, communication, and exploration. Unlike the real world, the metaverse is not limited by physical constraints, allowing users to fly, teleport to different locations, and even different metaverses.

The metaverse may include a virtual gym where the users may interact and perform activities individually or within a group to keep themself healthy and fit. These activities are controlled through a range of input devices such as controllers, keyboards, mice, virtual controllers, and gesture systems. Currently, there exist some mirror related systems that use external mechanical resistance measurement (such as, speed, distance, and weight lifted) for tracking a user's physical activity in real-world and projecting them into the metaverse.

However, these systems may have some limitations. For example, these systems may not always provide accurate measurements of the user's physical activity, especially when it comes to external resistance measurements, such as speed, distance, and weight lifted. Additionally, these systems may only be able to measure certain types of physical activities that involve external resistance, such as weightlifting or using exercise machines, and may not be able to track other forms of exercise, like running, performing yoga, or swimming. Further, these systems lack flexibility when it comes to exercise variation and personalized workout routines, which may make it difficult for the users to modify their workouts to suit their specific needs or preferences. Moreover, cost of these systems may be prohibitive for some users, as they may require expensive equipment or subscriptions, making them less accessible to those who cannot afford them.

Therefore, there is a need for an efficient and reliable AI based tool that is capable of tracking the user activity without the need of any external mechanical measurement and further providing on-demand AI assistive feedback to the user based on their activity performance into the metaverse or in the real-world.

### SUMMARY

In one embodiment, a method for providing an immersive and interactive fitness experience to a user is disclosed. The method may include identifying at least one of a pose and a movement corresponding to the user performing one or more activities in a real-world environment. The method may further include generating, in a metaverse or a virtual environment, an avatar corresponding to the user of the real-world environment based on the at least one of the pose and the movement identified. The avatar and the associated virtual environment may be customizable based on user's physical appearance, user preferences, or user performance (e.g., activity level, frequency of the activity performed, goals achieved by the user). The method may further include rendering the at least one of the pose and the movement identified in the avatar using an Extended Reality (XR) technique. The method may further include monitoring a pattern of the one or more activities being performed by the user in the real-world environment and the corresponding avatar in the metaverse or the virtual environment using an Artificial Intelligence (AI) model. The method may further include dynamically providing a feedback to at least one of the user and the avatar based on the monitoring. The feedback may be provided through an AI-assisted virtual expert in at least one of the real-world environment and the metaverse or the virtual environment.

In another embodiment, a system for providing an immersive and interactive fitness experience to a user is disclosed. The system may include a processor, and a memory communicatively coupled to the processor. The memory includes processor instructions, which when executed by the processor causes the processor to identify at least one of a pose and a movement corresponding to the user performing one or more activities in a real-world environment. The processor instructions may further generate, in a metaverse or a virtual environment, an avatar corresponding to the user of the real-world environment based on the at least one of the pose and the movement identified. The avatar and the associated virtual environment may be customizable based on user's physical appearance, user preferences, or user performance (e.g., activity level, frequency of the activity performed, goals achieved by the user). The processor instructions may further render the at least one of the pose and the movement identified in the avatar using an Extended Reality (XR) technique. The processor instructions may further monitor a pattern of the one or more activities being performed by the user in the real-world environment and the corresponding avatar in the metaverse or the virtual environment using an Artificial Intelligence (AI) model. The processor instructions may further dynamically provide a feedback to at least one of the user and the avatar based on the monitoring. The feedback may be provided through an AI-assisted virtual expert in at least one of the real-world environment and the metaverse or the virtual environment.

In yet another embodiment, a non-transitory computer-readable medium storing computer-executable instruction for providing an immersive and interactive fitness experience to a user is disclosed. The stored instructions, when executed by a processor, may cause the processor to perform operations including identifying at least one of a pose and a movement corresponding to the user performing one or more activities in a real-world environment. The operations may further include generating, in a metaverse or a virtual environment, an avatar corresponding to the user of the real-world environment based on the at least one of the pose and the movement identified. The avatar and the associated virtual environment may be customizable based on user's physical appearance, user preferences, or user performance (e.g., activity level, frequency of the activity performed, goals achieved by the user). The operations may further include rendering the at least one of the pose and the movement identified in the avatar using an Extended Reality (XR) technique. The operations may further include monitoring a pattern of the one or more activities being performed by the user in the real-world environment and the corresponding avatar in the metaverse or the virtual environment using an Artificial Intelligence (AI) model. The operations may further include dynamically providing a feedback to at least one of the user and the avatar based on the monitoring. The feedback may be provided through an AI-assisted virtual expert in at least one of the real-world environment and the metaverse or the virtual environment.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explains the disclosed principles.

FIGS. 1A-1F illustrate exemplary scenarios for providing an immersive and interactive fitness experience to a user, in accordance with some embodiments.

FIG. 2 illustrates a functional block diagram of a system for providing an immersive and interactive fitness experience to a user, in accordance with some embodiments.

FIG. 3 illustrates a flowchart of a method for providing an immersive and interactive fitness experience to a user, in accordance with some embodiments.

FIG. 4 illustrates a flowchart of a method for monitoring a pattern of one or more activities being performed by a user in real-world environment and a corresponding avatar in a metaverse or a virtual environment, in accordance with some embodiments.

FIG. 5 illustrates a flowchart of a method for providing a personalized feedback to a user and a corresponding avatar performing one or more activities individually, in accordance with some embodiments.

FIG. 6 illustrates a flowchart of a method for providing a generalized feedback to a set of users and corresponding avatars performing one or more activities in a group, in accordance with some embodiments.

FIG. 7 is a block diagram of an exemplary computer system for implementing embodiments consistent with some exemplary embodiments.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

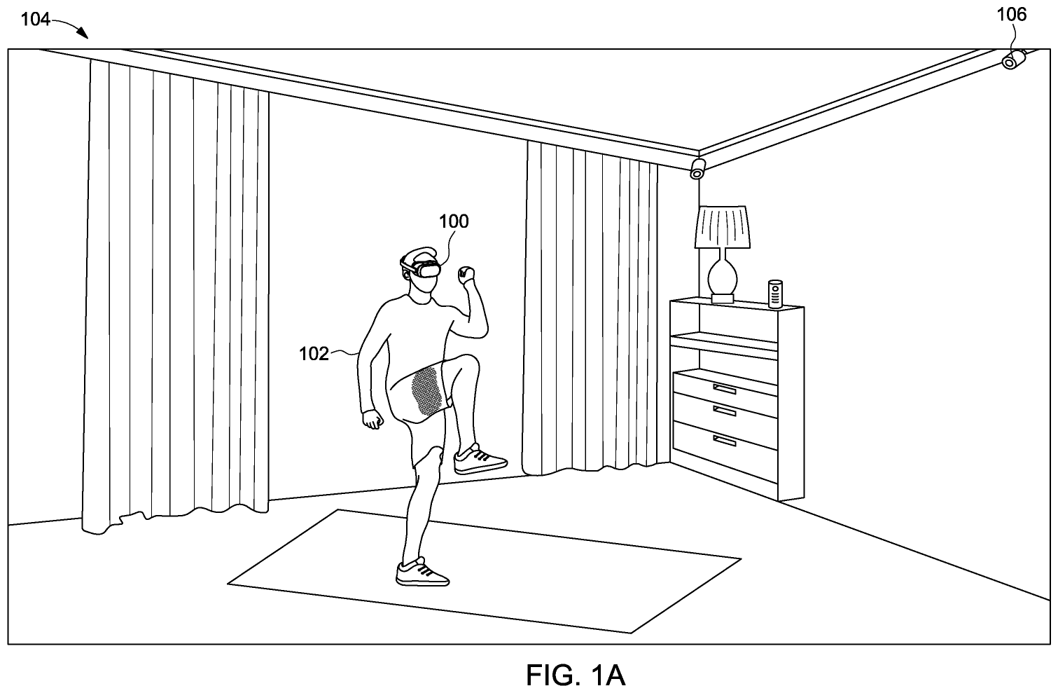

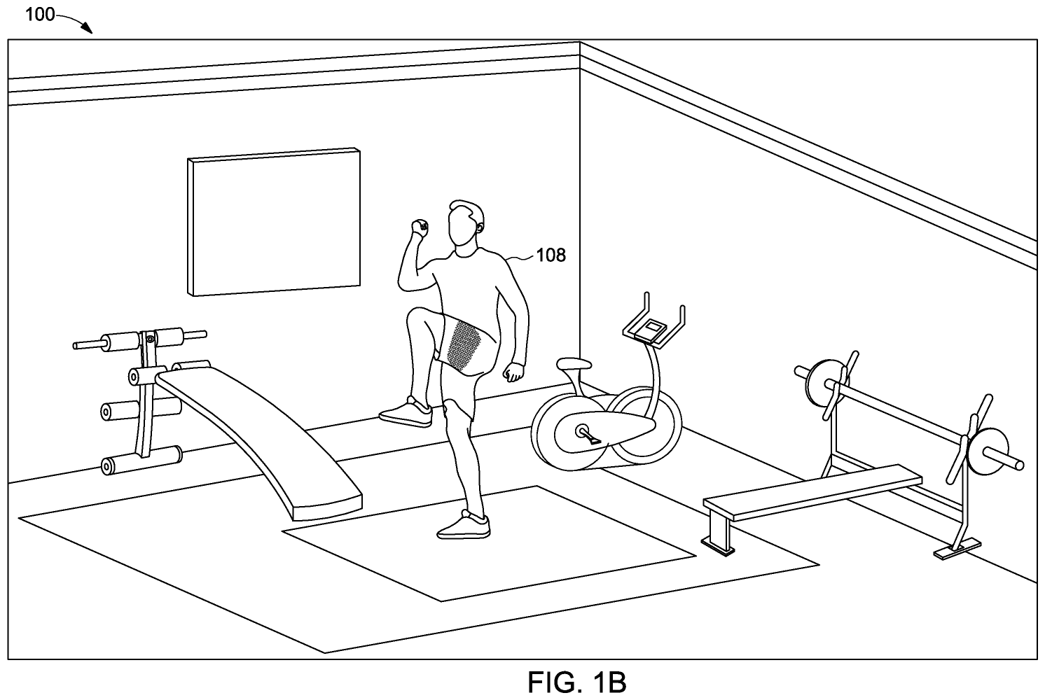

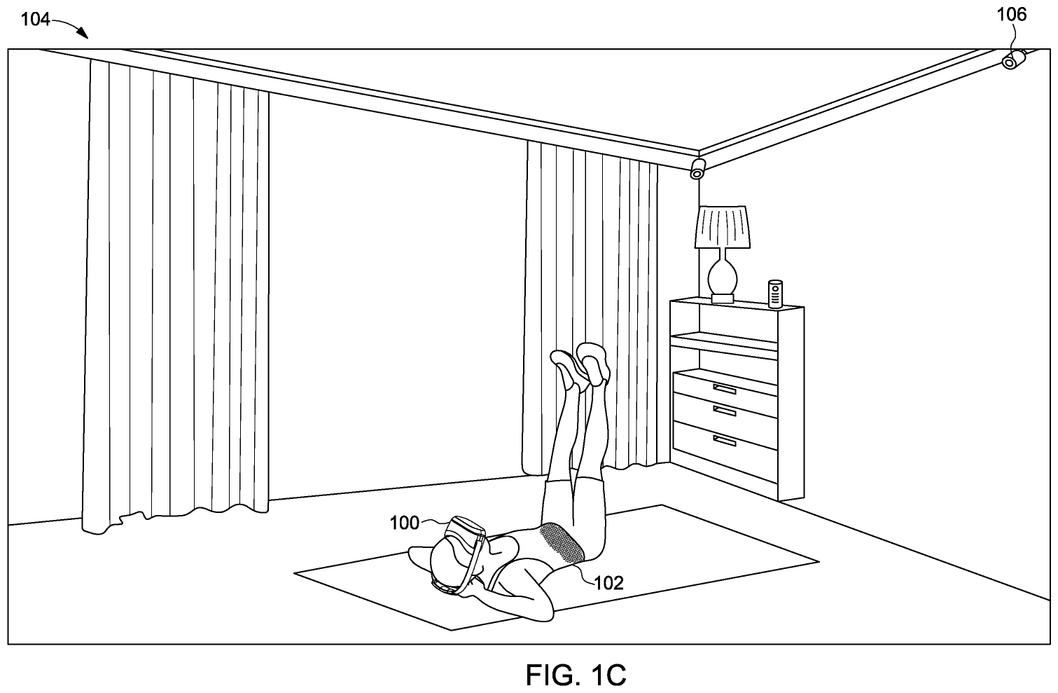

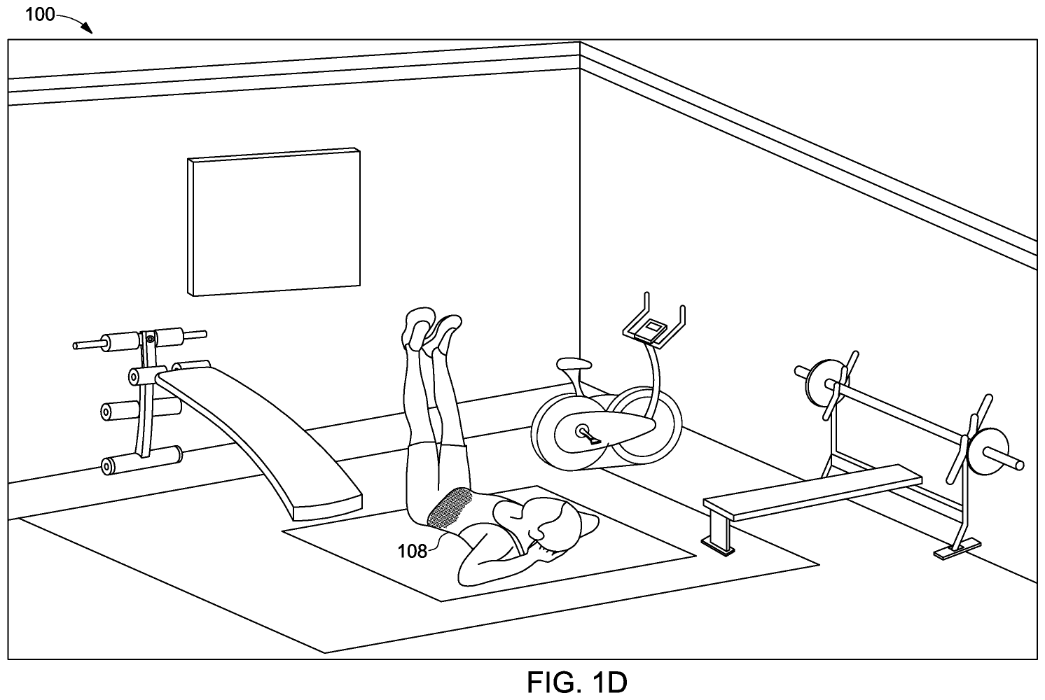

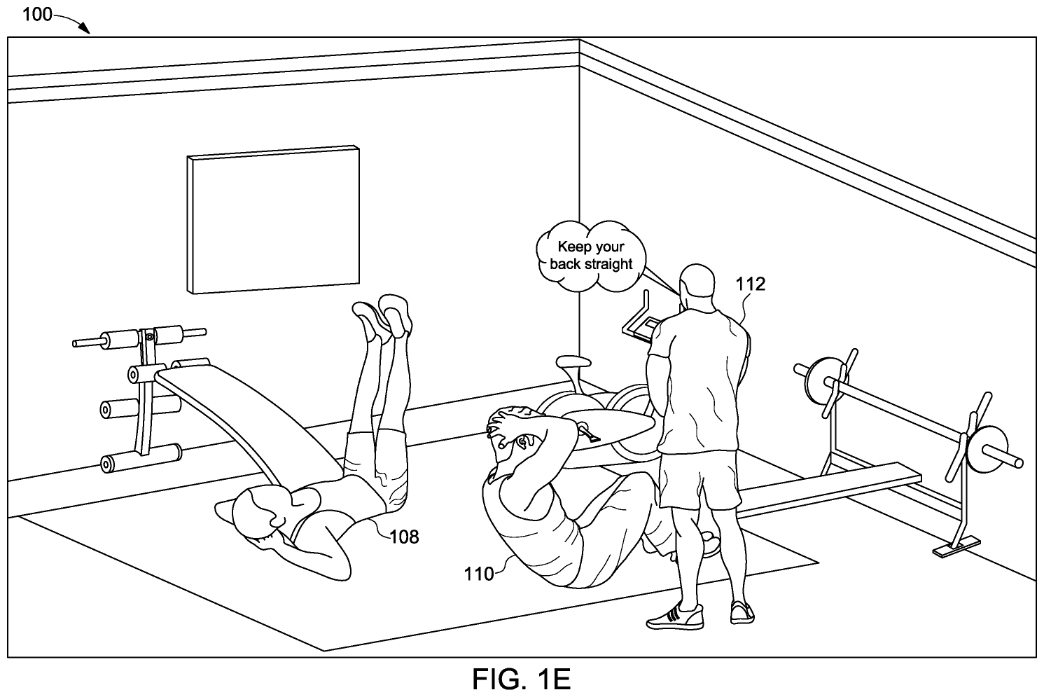

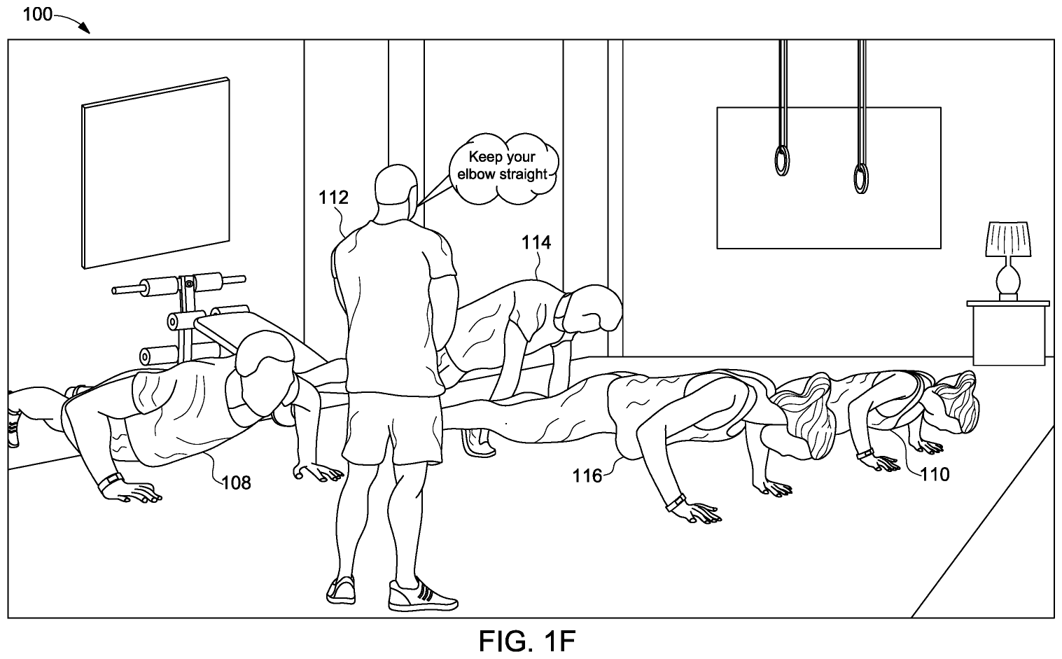

Referring now to FIGS. 1A-1F, exemplary scenarios for providing an immersive and interactive fitness experience to a user 102 is illustrated, in accordance with some embodiments. In an exemplary scenario, as illustrated in FIG. 1A and FIG. 1C, the user 102 may be performing one or more activities inside a room 104 of a real-world environment. At least one camera 106 may be installed within the room 104 to capture user's image, or physical appearance of the user 102 while performing one or more activities. The camera 106, for example, may be, but is not limited to a mobile or device camera, an infrared camera, a motion detection camera, or similar cameras with combination of one or more features.

The room 104 may be a part of, for example, a house, a gymnasium, a physiotherapy facility, a rehab facility, a Yoga studio, a dance studio, a theatre coaching centre, or the like. The user 102 performing the one or more activities may be, for example, but are not limited to, high knees, leg raises, crunches, jumping jacks, lateral squats, lunges, squats, burpees, overhead triceps, push-ups, dumbbell squat press, core scissors, elbow knee, a band lateral raise, a band lateral stretch, a hook, an uppercut, boxing, kettlebell, deadlift, dead bug, squat thrusters, yoga, or high-intensity interval training (HIIT). For the sake of explanation, in a current scenario, the user 102 may be performing a high knees activity and a leg raises activity to keep himself healthy and fit, as depicted via FIGS. 1A and 1C respectively.

In order to provide immersive and interactive fitness experience, the user 102 may be wearing an immersive fitness device 100 while performing the one or more activities inside the room 104. In some embodiments, the immersive fitness device 100 may be worn by the user 102 in an outdoor environment (for example, a public park). Examples of immersive fitness device 100 may include, but are not limited to, an Augmented Reality (AR) device (for example, AR glasses), a Virtual Reality (VR) device, a Mixed Reality (MR) device, a haptic device, a smart TV, or any other Extended Reality (XR) based wearable smart device and smart clothing devices with inbuilt display.

The immersive fitness device 100 may include a display, one or more processors (not shown in FIG. 1), a memory (not shown in FIG. 1), one or more sensors (not shown in FIG. 1), and a speaker (not shown FIG. 1). The display may include a Graphical User Interface (GUI). The memory may store various data that may be captured, processed, and/or required by the immersive fitness device 100. The memory may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random-Access Memory (DRAM), Static Random-Access memory (SRAM), etc.).

The one or more sensors may either be placed within the room 104 where the user 102 is located or may be placed partially or wholly on body of the user 102 to identify a pose and/or a movement of the user 102 while performing the one or more activities. Examples of the one or more sensors may include, but are not limited to, a Light Detection and Ranging (LiDAR), an infrared sensor, a motion sensor, a proximity sensor, a haptic sensor, a temperature sensor, a hear-rate sensor, a pulse sensor, a perspiration sensor, a pedometer, an oximeter, a humidity sensor, and the like.

The display of the immersive fitness device 100, for example, may include, but is not limited to a Liquid Crystal Display (LCD), a Light-Emitting Diode (LED) backlit LCD, a Thin-Film Transistor (TFT) LCD, an LED display, an Organic LED (OLED) display, an Active Matrix Organic LED (AMOLED) display, a Plasma Display Panel (PDP) display, a Quantum Dot LED (QLED) display, or the like.

In some embodiments, the immersive fitness device 100 may also interact with external devices over a network for sending and receiving data. For example, the external devices may be used by multiple users to access the metaverse for performing one or more activities in a metaverse gym. Examples of the external devices may include, but are not limited to, a computer, a tablet, a smartphone, and a laptop.

In the virtual environment created by the immersive fitness device 100, the user 102 may interact with some other users which are connected to the same network for performing the one or more activities together. For example, in the virtual environment (e.g., a virtual gym), the user 102 may talk to the other users about workout routines, share tips, or even participate in virtual group workouts together. Essentially, the user 102 has the ability to engage and interact with the other users in the virtual environment in much the same way they may in the real-world environment, despite being in a virtual space and not necessarily to be physically present at the same location. The network may be any wired or wireless communication network and the examples may include, but may be not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof, etc.

As illustrated in FIG. 1B and FIG. 1D, an exemplary scenario where the user 102 is wearing the immersive fitness device 100, and the display of the immersive fitness device 100 shows a graphical user interface (GUI) to the user 102. The GUI represents a virtual environment (such as, a metaverse or a virtual gym). In this virtual environment, the user 102 may see themselves as a digital representation called an avatar 108. The immersive fitness device 100 enables assessing functions, poses, gestures, orientation, movements, and the like of the user 102 in the real-world environment, and render the same poses or gestures as identified into the avatar 108 present in the virtual gym. It should be noted that the avatar 108 may be customized to look like the user 102 or take on a completely different appearance based on user's choice (for example, system parameters, adjustable parameter settings based on capabilities, frequency of activity performed, timing and duration of activity).

In other words, the metaverse or virtual gym may allow the user 102 to be represented by their real-world appearances, for example, the avatar 108 may possess similar physical attributes as of the user 102 in the real-world, or the user 102 may have an ability to change their appears based on performance. The physical attributes may include, but are not limited to, user's looks, skin colour, height, weight, physique, and the like. The virtual gym may include equipment, workout areas, and other users (not shown in FIGS. 1B and 1D) who are also connected to the same network. The display may be used to display multiple participants performing a group activity into the same metaverse or virtual environment and allowing the multiple participants to interact with each other. The virtual gym may help the user 102 feel more engaged and motivated during their workout, as well as provide new opportunities for socializing and connecting with others who share their fitness goals.

In some embodiments, the user 102 may select one or more activities to be performed in the real-world and these activities may be monitored or assessed via an Artificial Intelligence (AI) model. Alternatively, the activity selection in the real-world may be based on the AI model. Once the user 102 starts performing the one or more activities, the AI model may then detect, monitor, and understand a pattern of the activities been performed by the user 102. It should be noted that while performing the one or more activities by the user 102 in the real-word environment, a corresponding avatar 108 may be represented in the metaverse or virtual environment.

By the way of an example, when the user 102 performs a pushups activity in the real-world, the AI model may track movements of the user 102 performing the pushups activity. Based on this tracking, the AI model may determine a type of an activity the user 102 is performing. As an example, if the user 102 is performing the pushups activity and is in the pushups performing position, while doing up-down motion, then the AI model may determine the type of active as the pushups activity and the user 102 is performing the pushups activity. It may be noted that to recognize that the user 102 up-down motion corresponds to the pushups, the user's activity is required to be matched with a set of predefined activities that is already stored in a storage. The storage may be at least one of an online storage (for example, a server) or a device storage (for example, a memory). In some embodiments, the activity may be determined automatically by a trained AI model. The AI model may be trained based on the activity defined by the user 102. For example, the user 102 may provide input data corresponding to the activity (for example, a video of the trainer performing push-ups ten times) and the AI model may determine that activity when the user 102 performs it later.

In some embodiments, the immersive fitness device 100 may allow the user 102 to select the activity from the set of predefined activities which may be performed by the user 102 of the real-word and the corresponding avatar 108 in the virtual gym. Based on monitoring the user's activity, the AI model may then assign an AI assisted activity trainer i.e., a virtual expert with expertise derived from a human expert who may provide feedbacks to the users, based on user's performance.

As illustrated in FIG. 1E, an exemplary scenario of the virtual gym where a set of avatars (for example, avatar 108, and avatar 110) are performing one or more activities individually. The virtual gym includes an AI-assisted virtual expert 112 that monitors a pattern of the one or more activities being performed by the users and their corresponding avatars and further assists each of the users and their corresponding set of avatars to perform the one or more activities correctly. For example, as illustrated in the present FIG. 1E, the AI-assisted virtual expert 112 is assisting and providing an instruction ‘keep your back straight’ to the user or the corresponding avatar 110 during the performance of crunches, thereby helping the user or the corresponding avatar 110 to perform the crunches correctly.

Additionally, the AI-assisted virtual expert 112 may provide a personalized feedback to each of the set of avatars and their corresponding real-world users based on their performance. For example, if the user 102 is performing the activity poorly, then the AI-assisted virtual expert 112 may instruct the user 102 or their corresponding avatar 108 to repeat the same activity. Examples of AI-assisted virtual expert may include, but are not limited to, a trainer, an instructor, a coach, or a mentor that may have good knowledge of performing the one or more activities. It may be noted that the AI-assisted virtual expert 112 may provide feedback to the user 102 either in their real-world or to their respective avatar 108 in the metaverse or virtual environment, or both. The feedback may be in the form of positive encouragements, warnings, critical errors, accessible progress reports of the users, and the like. For example, the AI assisted virtual expert 112 may provide a warning to the user 102 in case the user 102 or the corresponding avatar 108 is not performing the activity accurately.

The feedback may be based on the users' current performances, previous activities, or the activities performed by the users in a group. Further, the feedback may also be provided to the users collectively as generalize feedback for the group or as individual feedback given to each of the avatars in the metaverse or the users in the real-world in the form of visual, audio, and/or haptic feedbacks.

As illustrated in FIG. 1F, an exemplary scenario of a virtual gym where a set of avatars (for example, avatar 108, avatar 110, avatar 114, and avatar 116) may perform workouts, compete, play group classes, or perform group activities. It may be noted that the set of avatars performing the group activities may appear to be in the real-world, or at the same time, but in actual, the activities may be performed at different times or may just be experienced in the metaverse or the virtual environment at the time the users are active.

In this scenario of the virtual gym, the AI-assistive virtual expert 112 may provide a generalized feedback to the set of avatars or multiple users (e.g., participants) performing together a group activity in the same metaverse thereby allowing the multiple users to interact or compete while performing the group activity. For example, as illustrated in present FIG. 1F, the AI-assisted virtual expert 112 is assisting the set of avatars (for example, avatar 108, avatar 110, avatar 114, and avatar 116) and instructing each of the avatars or their corresponding real-world users as ‘keep your elbow straight’ during the performance of push-up in the group activity.

In one embodiment, each of the set of avatars and their corresponding real-world users may be assigned with a personalized AI-assistive virtual expert that may provide personalized feedback to each of the set of avatars or users while engaging in a shared activity with the other users. In another embodiment, each of the set of avatars and their corresponding real-world users may be assigned with multiple personalized AI-assistive virtual experts. Each of the multiple personalized AI-assistive virtual experts may provide individual feedback to each of the set of avatars or the users related to different aspects of the activity, such as overall performance, relative performance, error and warning signal, encouragement, improvements, group goals, personal goals, and the like. In addition, the group activity may be accessible to other participants or users, such as coordinators who may be available virtually or projected into the metaverse from the real-world environment.

In some embodiments, the feedback to be rendered in the metaverse may be in a form which may not be restricted to the real-world form such as avatars but may also be provided in a form highlighted by virtual representations, such as, color, size, animation, sounds, haptic feedback, rewards, appearance, environment, and other augmentations of a body part of the users based on the user's skill, efficiency level, performance accuracy, or the activity level.

To further elaborate on the manner in which feedback is rendered to the user 102, the feedback may be rendered in an aural form (audio-based feedback), a visual form (video-based feedback, which may be static or dynamic), as haptic feedback, or the feedback may also be in the form of augmented reality or virtual reality elements, for example, AI-assistive virtual expert feedback within the metaverse or virtual environment. The visual form may include text in combination with various graphics displayed via the GUI. The aural or audio feedback may be audio instructions shared with the user 102 via speakers of the immersive fitness device 100 or headphones/earphones worn by the user 102. The feedback or instructions may be related to a corrective action with regards to each of the activities performed by the user 102 or may be messages of encouragement, appreciation, or motivation for the user 102.

By way of an example, the feedback rendered to the user 102 while performing the group activity with a group of participants may include ‘you are a best performer in the group’, ‘you are top performer in this group’, and ‘you can do better’. The audio feedback may also include rhythm audio cues, such as a metronome, which may be used to guide the user 102 as to repetitions of the activity or pace of performing the activity. A visual feedback may include the same instructions that are displayed to the user 102 via the display screen of the immersive fitness device 100. Thus, the visual feedback, for example, may include instructions in textual form that may be displayed on the immersive fitness device 100. Alternatively, the visual feedback may be UI elements overlayed over the avatar (for example, in metaverse or otherwise) of the user 102.

Considering another scenario of the virtual gym where gym equipment may be seen to accessed by avatars, whereby the equipment may include, but are not limited to, one or more virtually smart equipment such as rope, dumbbells, magnetic resistance, exercise bike, treadmill, barbells, rowing machine, and the like.

In the exemplary embodiment, when the user 102 selects to perform muscle strengthening exercise using a set of dumbbells of may be 5 kg weight, then the corresponding avatar 108 in the metaverse or virtual gym may appear to be holding the same set of virtual dumbbells having the similar weight or size for performing the same muscle strengthening exercise as may be required in the real-world environment. Thus, the avatar and the environment in the metaverse is a representation of the real-world users performing the activity or a group of activities.

Further, the improvement in the avatar representation may be based on the user's level of performing the activity or the user's activity history. For example, when the user 102 has performed an exhaustive workout, the user 102 may simmer or tend to show some muscles. Thus, the avatar in metaverse or virtual environment may reflect the real-world workout. As a result, the avatar may also start showing muscles, or the avatar may simmer by performing exhaustive workout, as shown in FIGS. 1A-1D. In some embodiments, the avatar appearances may be based on historical performances, or relative performances within one or more activity performance groups.

In an embodiment, the AI-assisted virtual expert 112 may render feedback to each of the avatars associated with the real-world users. This means the feedback or AI-assistive virtual expert 112 is only visible, perceivable and communicates to a specific user. For multiple users performing group activities or individual activities, there may be provided more than one AI-assisted virtual experts respectively. In particular, the AI-assisted virtual expert may be responsible to provide positive feedbacks to the users who have performed the activities more accurately. The positive feedbacks may be provided in a form of positive reinforcements, such as rewards, exchange points, or digital currency.

In some embodiments, the user 102 performing the group activity may receive multiple feedbacks from more than one AI-assisted virtual experts, for example, one feedback may be provided for counting the repetitions performed by the user 102, other may be for the way of performing the activity, or for the historical performance comparison of the user's activities. It should be noted that each user avatar in the metaverse or virtual environment may be engaged with a specific AI expert and the feedback provided based on each of the multiple AI-assistive virtual experts. Each of the AI-assistive virtual expert for specific user may wait for their turn for providing feedback.

In some embodiments, the metaverse or virtual environment may include a blockchain facility in which the user 102 may be allowed to do transactions for buying some valuable goods or Merlin goods, which may include, but are not limited to, avatar's skins, trainers, activity equipment, and the like. In one embodiment, the user 102 may buy such valuable products using the rewards, exchange points, or digital currency which the user 102 may receive based on their performance level, degree, improvement, skills, and the like. Also, when the user 102 buys some Merlin or partnered goods in the metaverse or virtual environment, then the goods may appear similar in the real-world as in the metaverse. Alternatively, when the user 102 earns or buys any Merlin goods or valuable goods in the metaverse, then these may be delivered as physical goods, items, QR codes, objects with identification, and the like, which may be received as goods in the real-world.

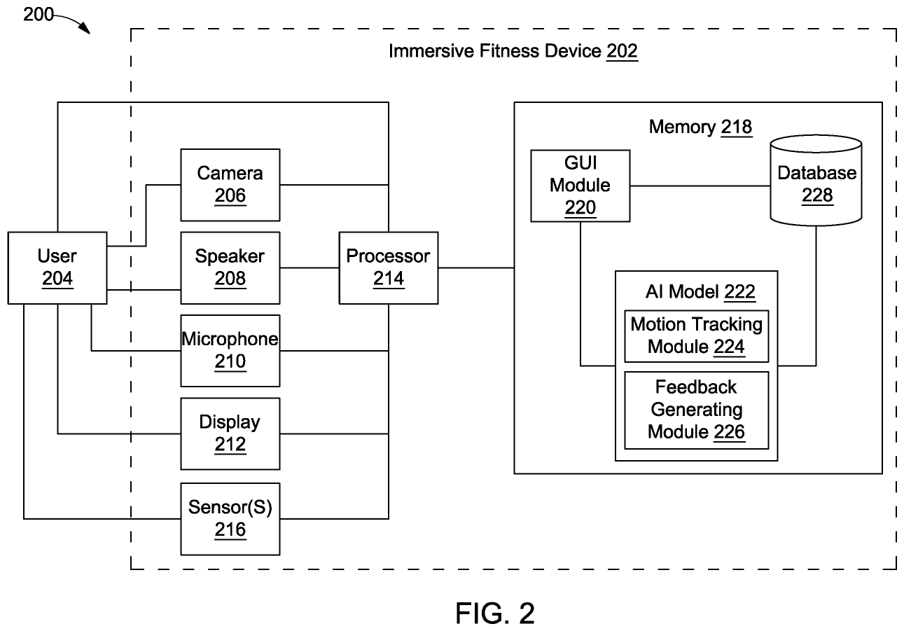

Referring now to FIG. 2, a functional block diagram of a system 200 for providing an immersive and interactive fitness experience to a user 204, in accordance with some embodiments. The system 200 includes an immersive fitness device 202. The immersive fitness device 202 is analogous to the immersive fitness device 100 of the FIG. 1. Further, the immersive fitness device 202 may include a camera 206, a speaker 208, a microphone 210, a display 212, a processor 214, one or more sensors 216, and a memory 218. The memory 218 further includes a Graphical User Interface (GUI) module 220, an AI model 222, and a database 228.

In order to provide the immersive and interactive fitness experience to the user 204, initially the camera 206 may capture poses, gestures, or physical appearances of the user 204 in the real-world environment. Further, the one or more sensors 216 (preferably a LiDAR sensor) may identify at least one of a pose and a movement (for example, an orientation, or a motion) of the user 204 while performing one or more activities in the real-world environment.

Once the pose and the movement of the user 204 is identified, the immersive fitness device 202 may further generate an avatar corresponding to the user 204 into the metaverse or the virtual environment. The metaverse may include a virtual gym where the avatar of the user 204 may perform one or more activities individually or may interact with avatars of other users to perform the one or more activities in a group. Within the metaverse, the users may engage with each other, form groups, and communicate with each other via the microphone 210. It may be noted that in the metaverse, the real-word users may be represented by the corresponding avatars.

Further, the pose and the movement identified may be rendered into the avatar of the metaverse or virtual environment using an Extended Reality (XR) technique. The XR technique uses a combination of Virtual Reality (VR) and Augmented Reality (AR) technologies to create a virtual environment that the user 204 may perceive as being real. Therefore, the XR technique may be utilized to enable the user 204 to see the one or more activities performed by the avatar via the display 212 in a way that is immersive and interactive.

Further, the AI model 222 may detect, monitor, and understand a pattern of the one or more activities being performed by the real-world user and their corresponding avatar in the metaverse or the virtual environment. The AI model 222 may include a motion tracking module 224, and a feedback generating module 226. The motion tracking module 224 may be configured to track a motion of the user and the corresponding avatar performing the one or more activities in the real-world environment and the metaverse or the virtual environment. Based on tracking the motion, the AI model 222 may determine a type of each of the one or more activities the user has performed. It should be noted that in order to determine the type of activity the user 204 is performing, the AI model 222 may get trained from a set of predefined activities that may be stored within the database 228.

In one embodiment, the AI model 222 may assign an AI-assistive virtual expert (such as the AI-assistive virtual expert 112) to the user 204 and a corresponding avatar (such as the corresponding avatar 108) that may assist or instruct the user 204 and avatar to perform the one or more activities correctly. In another embodiment, the AI model 222 may assign a set of AI-assistive virtual experts to each of the users and avatars to assist or instruct them to perform the group activity correctly.

Based on monitoring, the feedback generating module 226 may generate and dynamically provide feedback to at least one of the user and the avatar performing the one or more activities. It should be noted that the feedback may be provided through the AI-assisted virtual expert in at least one of the real-world environment and the metaverse or the virtual environment. The feedback rendered to the user 204 or the corresponding avatar may be in one or more of an aural form, a visual form, or as a haptic feedback. Examples of the feedback may include, but are not limited to ‘good work,’ keep your elbow straight, ‘keep your back straight,’ stretch your arms, and ‘incorrect posture or pace’ of the user while performing the at least one activity. The feedback may also include content related to user encouragement and motivation. It may be noted that feedback in the aural form may be provided to the user 204 via the speaker 208 and feedback in the visual form may be rendered to the user 204 via the display 212 and by the AI-assistive virtual expert. The haptic feedback may be rendered to the user 204 via haptic devices placed on the user 204 that may be activated to generate a vibration or force. Thus, an intensity of vibration may indicate the degree or error, and subsequent correction required while performing the one or more activities.

It should be noted that all such modules 206-226 may be represented as a single module or a combination of different modules. Further, as will be appreciated by those skilled in the art, each of the modules 206-226 may reside, in whole or in parts, on one device or multiple devices in communication with each other. In some embodiments, each of the modules 206-226 may be implemented as dedicated hardware circuit comprising custom application-specific integrated circuit (ASIC) or gate arrays, off-the-shelf semiconductors such as logic chips, transistors, or other discrete components. Each of the modules 206-226 may also be implemented in a programmable hardware device such as a field programmable gate array (FPGA), programmable array logic, programmable logic device, and so forth. Alternatively, each of the modules 206-226 may be implemented in software for execution by various types of processors. An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for providing an immersive and interactive fitness experience to a user. For example, the system 200 and the associated immersive fitness device 202 may provide the immersive and interactive fitness experience to the user as discussed herein. As will be appreciated by those of ordinary skill in the art, a control logic and/or automated routines for performing the techniques and the steps described herein may be implemented by the system 200 and the associated immersive fitness device 202 either by hardware, software, or combinations of hardware and software. For example, suitable code may be accessed and executed by the one or more processors on the system 200 to perform some or all the techniques described herein. Similarly, applications specific to integrated circuits (ASICs) configured to perform some or all the processes described herein may be included in the one or more processors on the system 200.

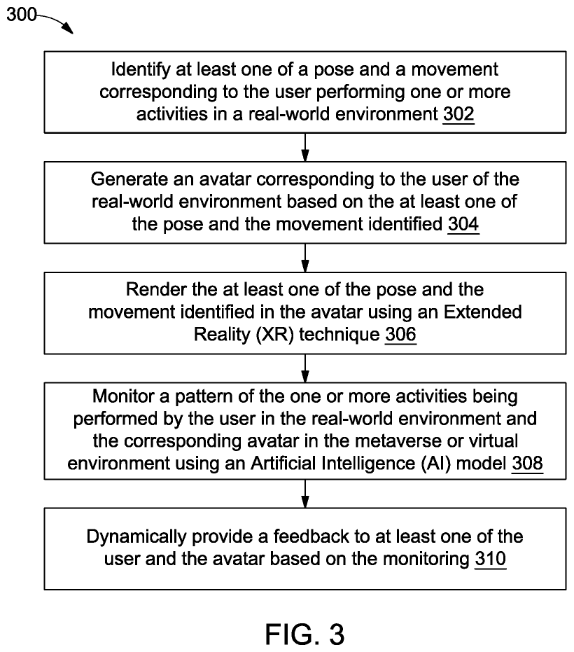

Referring now to FIG. 3, a flowchart of a method 300 for providing an immersive and interactive fitness experience to a user is illustrated, in accordance with some embodiments. At step 302, at least one of a pose and a movement corresponding to the user performing one or more activities may be identified in a real-world environment. In should be noted that prior to identifying the pose and movement of the user, a physical appearance of the user may be captured in the real-world environment via a capturing module (for example, the camera 206).

Once the at least one of the pose and the movement are identified, at step 304, an avatar corresponding to the user of the real-world environment may be generated in a metaverse or a virtual environment, based on the at least one of the pose and the movement identified. The metaverse or the virtual environment may be one of a VR environment, an AR environment, an MR environment, or an XR environment. It should be noted that the avatar and the virtual environment may be customizable based on user's physical appearance, user preferences, or user performance. For example, the avatar may either possess similar physical attributes as of the user in the real-world or take on a completely different appearance based on user's choice (for example, system parameters, adjustable parameter settings based on capabilities, frequency of activity performed, timing and duration of activity). The physical attributes may include, but are not limited to, user's looks, skin colour, height, weight, physique, and the like.

Further, at step 306, the at least one of the pose and the movement identified may be rendered in the avatar using an XR technique. The XR technique may be utilized to enable the user to see the one or more activities performed by the avatar via a display (such as the display 212) in a way that is immersive and interactive. The one or more activities may include high knees, leg raises, crunches, jumping jacks, lateral squats, lunges, squats, burpees, overhead triceps, push-ups, dumbbell squat press, core scissors, elbow knee, a band lateral raise, a band lateral stretch, a hook, an uppercut, boxing, kettlebell, deadlift, dead bug, squat thrusters, yoga, or high-intensity interval training (HIIT).

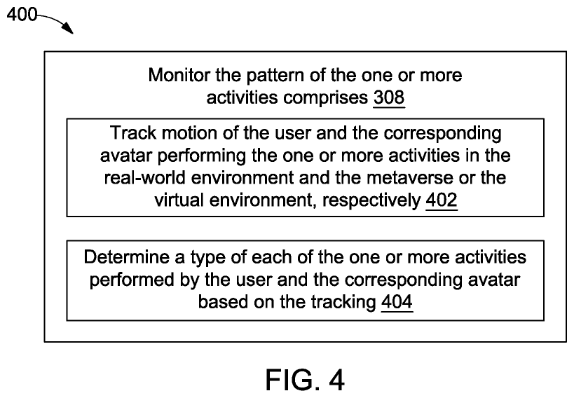

Further, at step 308, a pattern of the one or more activities being performed by the user in the real-world environment and the corresponding avatar in the metaverse or the virtual environment may be monitored using an AI model. A method of monitoring the pattern of the one or more activities is explained in conjunction with FIG. 4.

Based on monitoring, at step 310, a feedback may be dynamically provided to at least one of the user and the avatar. It should be noted that the feedback may be provided through an AI-assisted virtual expert in at least one of the real-world environment and the metaverse or the virtual environment. The feedback may be provided in one of a visual form, an audio form, or a haptic form. The feedback may be one of a positive encouragement feedback provided to the user or the corresponding avatar when performing the one or more activities correctly, a warning or a critical error feedback provided to the user or the corresponding avatar when performing the one or more activities incorrectly, or a feedback provided in a form of accessible progress report of the user or the corresponding avatar performing the one or more activities.

In some embodiments, the AI-assistive activity trainer may provide positive feedbacks to the users who have performed the one or more activities accurately. The positive feedbacks may be provided in the form of positive reinforcements, such as rewards, exchange points, or digital currency. This has already been explained in detail in conjunction to the description to FIGS. 1A-1F.

Referring now to FIG. 4, a flowchart of a method 400 for monitoring a pattern of the one or more activities being performed by the user in the real-world environment and the corresponding avatar in a metaverse or a virtual environment is illustrated, in accordance with some embodiments. As mentioned via the step 308, in order to monitor the pattern of the one or more activities, at step 402, a motion of the user and the corresponding avatar performing the one or more activities in the real-world environment and in the metaverse or the virtual environment may be tracked by the AI model 222.

Further, at step 404, a type of each of the one or more activities performed by the user and the corresponding avatar may be determined based on the tracking. In order to determine the type, the user's activity is required to be matched with a set of predefined activities that is already stored in a storage. In some embodiments, the type of the one or more activities may be determined automatically by an AI model (such as the AI model 222).

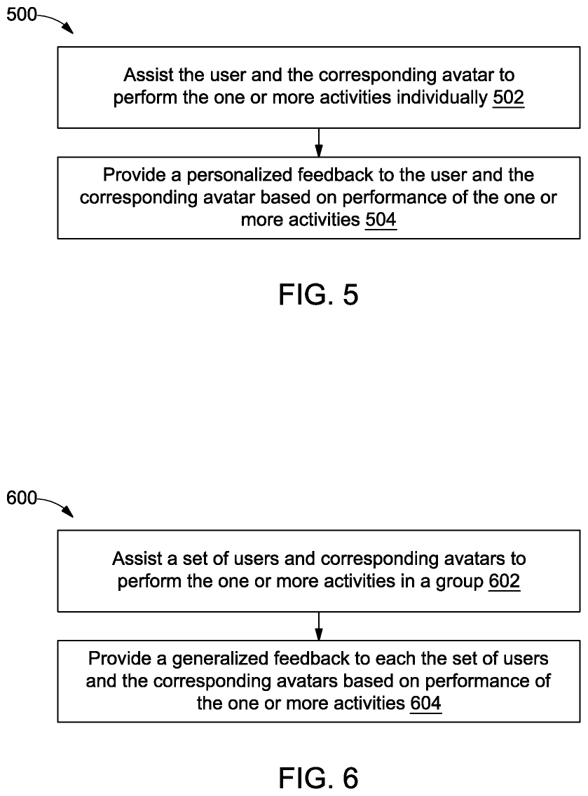

Referring now to FIG. 5, a flowchart of a method 500 for providing a personalized feedback to the user and the corresponding avatar performing one or more activities individually is illustrated, in accordance with some embodiments. Upon monitoring the the pattern of the one or more activities, at step 502, the user and the corresponding avatar may be assisted by the AI-assisted virtual expert to perform the one or more activities individually. By way of an example, consider a scenario where the user participates in personal training provided by the AI-assisted virtual expert. In this case, if the user is performing crunches poorly, then the AI-assisted virtual expert may provide instruction ‘keep your back straight’ in order to help the user or avatar to perform the crunches correctly.

At step 504, a personalized feedback may be provided to the user and the corresponding avatar based on performance of the one or more activities. For example, if the user is performing the crunches correctly, then the feedback or instructions of the AI-assisted virtual expert may be related to encouragement, appreciation, or motivation for the user, such as ‘good work’, ‘keep it up’, etc.

Referring now to FIG. 6, a flowchart of a method 600 for providing a generalized feedback to a set of users and corresponding avatars performing one or more activities in a group, in accordance with some embodiments. Upon monitoring the the pattern of the one or more activities, at step 602, the user and the corresponding avatar may be assisted by the AI-assisted virtual expert to perform the one or more activities in a group. By way of an example, consider a scenario where a set of users participates in group activity provided by the AI-assisted virtual expert. In this case, the AI-assisted virtual expert may provide a general instruction for each of the set of users taking part in the group activity so as to improve their activity skills.

Further, at step 604, a generalized feedback may be provided to the set of users and the corresponding avatars based on performance of the one or more activities. The generalized feedback rendered to the set of users and their respective avatars while performing the group activity with a group of participants. For example, the generalized feedback may include ‘you are a best performer in the group’, ‘you are top performer in this group’, ‘you can do better’, etc. This has already been explained in detail in the aforementioned description.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code may be loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code may be loaded into and executed by a computer, the computer becomes an apparatus for practicing the invention. When implemented on a general-purpose microprocessor, the computer program code segments configure the microprocessor to create specific logic circuits.

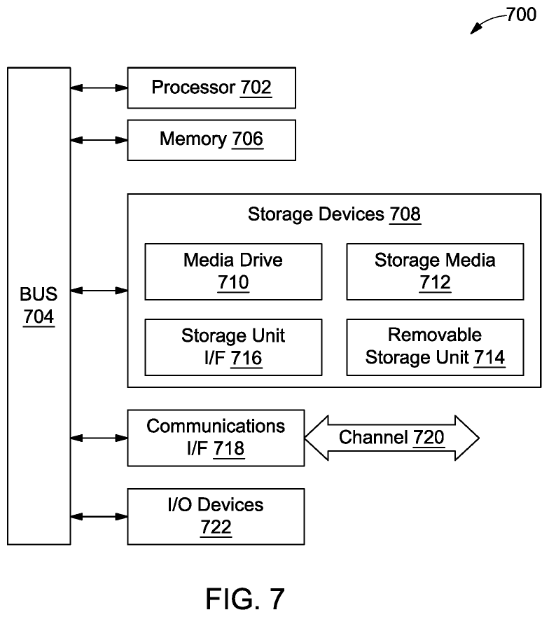

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller, or other control logic. In this example, the processor 702 is connected to a bus 704 or other communication medium. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 702.

The computing system 700 may also include a storage device 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored there in particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro-USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or another communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

As will be appreciated by those skilled in the art, the techniques described in the various embodiments discussed above are not routine, or conventional, or well understood in the art. The techniques discussed above provide for providing an immersive and interactive fitness experience to a user. The techniques first identify at least one of a pose and a movement corresponding to the user performing one or more activities in a real-world environment. The techniques may then generate, in a metaverse or a virtual environment, an avatar corresponding to the user of the real-world environment based on the at least one of the pose and the movement identified. The avatar may be customizable based on user's physical appearance or user preferences. The techniques may then render the at least one of the pose and the movement identified in the avatar using an XR technique. The techniques may then monitor a pattern of the one or more activities being performed by the corresponding avatar in the metaverse or the virtual environment using an AI model. The techniques may then dynamically provide a feedback to at least one of the user and the avatar based on the monitoring. The feedback may be provided through an AI-assisted virtual expert in at least one of the real-world environment and the metaverse or the virtual environment.

Thus, the disclosed method and system provide some advantages, like, the disclosed method and system may be able to render user pose and activity into the metaverse in the form of avatar and provide AI based feedback to the user and corresponding avatar in an immerse form. Further, the disclosed method and system may be able to project multiple participants performing a group activity into the same metaverse and allows them to interact, while each can see a personalized AI assistive avatar. The users are not required to meet in the real-world or at the same time to compete and participate in a shared activity.

In addition, the group activity may be joined by other metaverse participants such as, coordinators (which may be virtual or projections into the metaverse). Further, the avatar representation of the real-world user may be enhanced by their skill level or activity history. For example, someone who has done a lot of body work may be simmer or show muscles. Further the avatar may be augmented to show the results of a workout. For example, muscle groups that have been worked. Further, the disclosed method and system may provide the AI-assistive expert that may provide on demand personalized feedback to each avatar or user performing activities. This feedback may be based on the user's current performance, previous activities, and the activities of the group. The group activities may appear to be in real-time however, in actuality they may be performed at different time and just experienced in the metaverse at the time a user is active.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system providing an immersive and interactive fitness experience to a user. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for providing an immersive and interactive fitness experience to a user, the method comprising:
identifying at least one of a pose and a movement corresponding to the user performing one or more activities in a real-world environment;
generating, in a metaverse or a virtual environment, an avatar corresponding to the user of the real-world environment based on the at least one of the pose and the movement identified, wherein the avatar and the associated virtual environment is customizable based on one of a user's physical appearance, user preferences, or user performance;
rendering the at least one of the pose and the movement identified in the avatar using an Extended Reality (XR) technique;
monitoring a pattern of the one or more activities being performed by the user in the real-world environment and the corresponding avatar in the metaverse or virtual environment using an Artificial Intelligence (AI) model; and
dynamically providing a feedback to at least one of the user and the avatar based on the monitoring, wherein the feedback is provided through an AI-assisted virtual expert in at least one of the real-world environment and the metaverse or the virtual environment.

2. The method of claim 1, comprises capturing a physical appearance of the user in the real-world environment via a capturing module.

3. The method of claim 1, wherein monitoring the pattern of the one or more activities comprises:
tracking, by the AI model, motion of the user and the corresponding avatar performing the one or more activities in the real-world environment and the metaverse or the virtual environment, respectively; and
determining, by the AI model, a type of each of the one or more activities performed by the user and the corresponding avatar based on the tracking.

4. The method of claim 1, wherein the feedback comprises one of a positive encouragement feedback provided to the user or the corresponding avatar when performing the one or more activities correctly, a warning or a critical error feedback provided to the user or the corresponding avatar when performing the one or more activities incorrectly, or a feedback provided in a form of accessible progress report of the user or the corresponding avatar performing the one or more activities.

5. The method of claim 1, wherein the feedback is provided in one of a visual form, an audio form, or a haptic form.

6. The method of claim 1, further comprising:
assisting, by the AI-assisted virtual expert, the user and the corresponding avatar to perform the one or more activities individually; and
providing, by the AI-assisted virtual expert, a personalized feedback to the user and the corresponding avatar based on performance of the one or more activities.

7. The method of claim 1, further comprising:
assisting, by the AI-assisted virtual expert, a set of users and corresponding avatars to perform the one or more activities in a group; and
providing, by the AI-assisted virtual expert, a generalized feedback to each the set of users and the corresponding avatars based on performance of the one or more activities. wherein the set of avatars performing the group activities are presented as if they are physically present in the real-world, but the activities are actually performed at different times or experienced solely in the metaverse or virtual environment when the user is actively engaged.

8. The method of claim 7, wherein when the user is actively engaged in the metaverse or virtual environment, the set of users and corresponding avatars performing the group activities are presented as if physically present in the real-world environment at the same time, for the activities performed at different times and locations.

9. The method of claim 1, wherein the metaverse or the virtual environment is one of a virtual reality (VR) environment, an augmented reality (AR) environment, a mixed reality (MR) environment, or an XR environment.

10. The method of claim 1, wherein the one or more activities comprises of high knees, leg raises, crunches, jumping jacks, lateral squats, lunges, squats, burpees, overhead triceps, push-ups, dumbbell squat press, core scissors, elbow knee, a band lateral raise, a band lateral stretch, a hook, an uppercut, boxing, kettlebell, deadlift, dead bug, squat thrusters, yoga, or high-intensity interval training (HIIT).

11. A system providing an immersive and interactive fitness experience to a user, the system comprising:
a processor; and
a memory communicatively coupled to the processor, wherein the memory stores processor-executable instructions, which, on execution, causes the processor to:
identify at least one of a pose and a movement corresponding to the user performing one or more activities in a real-world environment;
generate, in a metaverse or a virtual environment, an avatar corresponding to the user of the real-world environment based on the at least one of the pose and the movement identified, wherein the avatar and the associated virtual environment is customizable based on user's physical appearance, user preferences, or user performance;
render the at least one of the pose and the movement identified in the avatar using an Extended Reality (XR) technique;
monitor a pattern of the one or more activities being performed by the user in the real-world environment and the corresponding avatar in the metaverse or the virtual environment using an Artificial Intelligence (AI) model; and
dynamically provide a feedback to at least one of the user and the avatar based on the monitoring, wherein the feedback is provided through an AI-assisted virtual expert in at least one of the real-world environment and the metaverse or the virtual environment.

12. The system of claim 11, wherein, the processor-executable instructions further cause the processor to capture a physical appearance of the user in the real-world environment via a capturing module.

13. The system of claim 11, wherein, to monitor the pattern of the one or more activities, the processor-executable instructions further cause the processor to:
track, by the AI model, motion of the user and the corresponding avatar performing the one or more activities in the real-world environment and metaverse or the virtual environment, respectively; and
determine, by the AI model, a type of each of the one or more activities performed by the user and the corresponding avatar based on the tracking.

14. The system of claim 11, wherein the feedback comprises one of a positive encouragement feedback provided to the user or the corresponding avatar when performing the one or more activities correctly, a warning or a critical error feedback provided to the user or the corresponding avatar when performing the one or more activities incorrectly, or a feedback provided in a form of accessible progress report of the user or the corresponding avatar performing the one or more activities.

15. The system of claim 11, wherein the feedback is provided in one of a visual form, an audio form, or a haptic form.

16. The system of claim 11, wherein the processor-executable instructions further cause the processor to:
assist, by the AI-assisted virtual expert, the user and the corresponding avatar to perform the one or more activities individually; and
provide, by the AI-assisted virtual expert, a personalized feedback to the user and the corresponding avatar based on performance of the one or more activities.

17. The system of claim 11, wherein the processor-executable instructions further cause the processor to:
assist, by the AI-assisted virtual expert, a set of users and corresponding avatars to perform the one or more activities in a group; and
provide, by the AI-assisted virtual expert, a generalized feedback to each the set of users and the corresponding avatars based on performance of the one or more activities.

18. The system of claim 17, wherein when the user is actively engaged in the metaverse or virtual environment, the set of users and corresponding avatars performing the group activities are presented as if physically present in the real-world environment at the same time, for the activities performed at different times and locations.

19. The system of claim 11, wherein the metaverse or the virtual environment is one of a virtual reality (VR) environment, an augmented reality (AR) environment, a mixed reality (MR) environment, or an XR environment.

20. The system of claim 11, wherein the one or more activities comprises of high knees, leg raises, crunches, jumping jacks, lateral squats, lunges, squats, burpees, overhead triceps, push-ups, dumbbell squat press, core scissors, elbow knee, a band lateral raise, a band lateral stretch, a hook, an uppercut, boxing, kettlebell, deadlift, dead bug, squat thrusters, yoga, or high-intensity interval training (HIIT).

21. A non-transitory computer-readable medium storing computer-executable instructions for providing an immersive and interactive fitness experience to a user, the computer-executable instructions configured for:
identifying at least one of a pose and a movement corresponding to the user performing one or more activities in a real-world environment;
generating, in a metaverse or a virtual environment, an avatar corresponding to the user of the real-world environment based on the at least one of the pose and the movement identified, wherein the avatar and the associated virtual environment is customizable based on one of a user's physical appearance, user preferences, or user performance;
rendering the at least one of the pose and the movement identified in the avatar using an Extended Reality (XR) technique;
monitoring a pattern of the one or more activities being performed by the user in the real-world environment and the corresponding avatar in the metaverse or the virtual environment using an Artificial Intelligence (AI) model; and
dynamically providing a feedback to at least one of the user and the avatar based on the monitoring, wherein the feedback is provided through an AI-assisted virtual expert in at least one of the real-world environment and the metaverse or the virtual environment.
